(19) United States
(12) Patent Application Publication
(10) Pub. No.: US 2024/0375635 A1
(43) Pub. Date: Nov. 14, 2024

(54) METHOD AND CONTROL SYSTEM FOR PERFORMANCE-OPTIMIZED CONTROL OF AN ELECTRIC VEHICLE POWERTRAIN

(71) Applicants: HYUNDAI MOTOR COMPANY, Seoul (KR); KIA CORPORATION, Seoul (KR)

(72) Inventors: Giulia Ludovici, Gross Gerau (DE); Burak Ulas, Mainz (DE); Ciprian Antaloae, Wiesbaden (DE)

(73) Assignees: HYUNDAI MOTOR COMPANY, Seoul (KR); KIA CORPORATION, Seoul (KR)

(21) Appl. No.: 18/370,719

(22) Filed: Sep. 20, 2023

(30) Foreign Application Priority Data
May 10, 2023 (DE) 102023112258.4

(51) Int. Cl. B60W 20/12; B60W 10/06; B60W 10/08; B60W 10/119; B60W 10/196

(52) U.S. Cl. CPC B60W 20/12; B60W 10/06; B60W 10/08; B60W 10/119; B60W 10/196; B60W 2510/0638; B60W 2510/081; B60W 2510/244; B60W 2510/246; B60W 2520/10; B60W 2520/105; B60W 2540/10; B60W 2540/18; B60W 2552/05

(57) ABSTRACT

A method and control system for performance-optimized control of a powertrain of an electric vehicle are disclosed. The method includes acquiring vehicle status data along a specified drive route for the electric vehicle. The vehicle status data includes a state of charge of a traction battery and a battery temperature of the traction battery. The method also includes determining a current position of the electric vehicle along the specified drive route. The method includes receiving driver requests and continuously controlling, based on a real-time control function using the vehicle status data, the current position, and the driver requests as input data, at least one control parameter along the specified drive route. The real-time control function is adapted to minimize a travel time along at least a portion of the specified drive route while conforming to pre-defined constraints on the vehicle status data.

### CROSS-REFERENCE TO RELATED APPLICATION

This application claims the benefit of and priority to German Patent Application No. 102023112258.4, filed on May 10, 2023, the entire contents of which are incorporated herein by reference.

### TECHNICAL FIELD

The present disclosure relates to a method and a control system for performance-optimized control of an electric vehicle powertrain as well as to an electric vehicle equipped with such a control system.

### BACKGROUND

The automotive mass production sector has moved towards hybrid and electric solutions with the main goal of reducing carbon dioxide (CO₂) emissions especially during conventional daily driving. High-performance brands, such as, e.g., Hyundai's N line of high-performance cars represent an important niche of the overall original equipment manufacturer (OEM) market. Such high-performance brands demonstrate the ability of the companies to implement advanced solutions with the intent of obtaining the best car performance in addition to reducing CO₂ emissions, thus making the brand more attractive to customers.

Electric/hybrid sports cars for use on closed race circuits and electric race cars in motorsport share an important goal of controlling the powertrain of the electric/hybrid sports car along the driving distance to maintain performance at the highest possible level.

Document U.S. Pat. No. 7,954,579 B2 describes a control strategy for a hybrid electric vehicle having an electric motor, a battery, and an internal combustion engine. The control strategy improves fuel economy and reduces emissions while providing sufficient acceleration over a varying set of driving conditions through an adaptive control unit with an artificial neural network. The artificial neural network is trained on a pre-processed training set based on the highest fuel economies of multiple control strategies and multiple driving profiles. Training the artificial neural network includes a training algorithm and a learning algorithm. The document also describes a method of operating a hybrid electric vehicle with an adaptive control strategy using an artificial neural network.

Document U.S. Pat. No. 8,121,767 B2 describes a method for controlling torque in a hybrid powertrain system to selectively transfer mechanical power to an output member. The method includes monitoring operator inputs to an accelerator pedal and to a brake pedal. An immediate accelerator output torque request, a predicted accelerator output torque request, an immediate brake output torque request, a predicted brake output torque request, and an axle torque response type are determined. An output torque command to the output member of the transmission is determined based upon the immediate accelerator output torque request and the immediate brake output torque request.

### SUMMARY

Embodiments of the present disclosure provide solutions for powertrain control that are optimized for high-performance applications along a pre-determined route.

To this end, the present disclosure provides a method, a control system, and an electric vehicle.

According to one aspect of the present disclosure, a method for performance-optimized control of a powertrain of an electric vehicle is provided. The method includes acquiring, by a sensor system of the electric vehicle, vehicle status data of the electric vehicle along a specified drive route for the electric vehicle. The vehicle status data includes a state of charge (SOC) of a traction battery of the electric vehicle and a battery temperature of the traction battery. The method also includes determining, by a navigation system, a current position of the electric vehicle along the specified drive route. The method additionally includes receiving driver requests via a driver interface of the electric vehicle. The method further includes continuously controlling, by a system controller of the electric vehicle based on a real-time control function using the vehicle status data, the current position, and the driver requests as input data, at least one control parameter along the specified drive route. The at least one parameter includes at least one of i) a torque distribution among a first electric machine driving a front axle of the electric vehicle and a second electric machine driving a back axle of the electric vehicle or ii) a torque distribution among an electric machine of the electric vehicle and an internal combustion engine of the electric vehicle. The real-time control function is adapted to minimize a travel time along at least a portion of the specified drive route while conforming to one or more pre-defined constraints on the vehicle status data.

According to another aspect of the present disclosure, a control system for performance-optimized control of a powertrain of an electric vehicle is provided. The control system includes a sensor system configured to acquire vehicle status data of the electric vehicle along a specified drive route of the electric vehicle. The vehicle status data includes a state of charge (SOC) of a traction battery of the electric vehicle and a battery temperature of the traction battery. The control system also includes a navigation system configured to determine a current position of the electric vehicle along the drive route. The control system further includes a driver interface configured to receive driver requests. The control system additionally includes a system controller configured to continuously control, based on a real-time control function using the vehicle status data, the current position, and the driver requests as input data, at least one control parameter along the specified drive route. The at least one control parameter includes at least one of i) a torque distribution among a first electric machine driving a front axle of the electric vehicle and a second electric machine driving a back axle of the electric vehicle or ii) a torque distribution among an electric machine of the electric vehicle and an internal combustion engine of the electric vehicle. The real-time control function is adapted to minimize a travel time along at least a portion of the specified drive route while conforming to one or more pre-defined constraints on the vehicle status data.

According to yet another aspect of the present disclosure, an electric vehicle is provided that includes a control system for performance-optimized control of a powertrain of the electric vehicle. The control system includes a sensor system configured to acquire vehicle status data of the electric vehicle along a specified drive route of the electric vehicle. The vehicle status data includes a state of charge (SOC) of a traction battery of the electric vehicle and a battery temperature of the traction battery. The control system also includes a navigation system configured to determine a current position of the electric vehicle along the drive route. The control system further includes a driver interface configured to receive driver requests. The control system additionally includes a system controller configured to continuously control, based on a real-time control function using the vehicle status data, the current position, and the driver requests as input data, at least one control parameter along the specified drive route. The at least one control parameter includes at least one of i) a torque distribution among a first electric machine driving a front axle of the electric vehicle and a second electric machine driving a back axle of the electric vehicle or ii) a torque distribution among an electric machine of the electric vehicle and an internal combustion engine of the electric vehicle. The real-time control function is adapted to minimize a travel time along at least a portion of the specified drive route while conforming to one or more pre-defined constraints on the vehicle status data.

Embodiments of the present disclosure provide a control strategy that provides an optimal power split between electrical and thermal power sources and/or between front and rear axles to aim for the best performance (e.g. lap time, race performances etc.), thereby optimizing electric energy usage and avoiding thermal limitations on the performance of the electric components. Embodiments of the present disclosure provide an improvement of powertrain control architectures for electric and/or hybrid sports/racing cars with optimal usage of battery energy, avoiding the thermal power degradation of electric components.

To this end, embodiments of the present disclosure provide a flexible solution that is applicable to a specified track under varying driving styles and introduces the possibility to combine or shift between different strategies within a powertrain control unit (PCU), e.g. qualifying for a single launched lap or race strategy to get the best performances on multiple laps. Embodiments of the present disclosure may be used in battery electric vehicles in which electric power may be split between rear/front axles as well as hybrid vehicles where the power split may also be optimized between thermal and electric source, i.e., internal combustion engine and electric machine.

For a long racetrack with significant elevation changes, the strategy chosen for energy use and thermal degradation may strongly affect the average speed, especially if multiple consecutive laps (i.e., longer distance) need to be taken for achieving the best lap times. Embodiments of the present disclosure provide a control architecture that enables the driver to achieve the best performance on a specified drive route (e.g., circuit laps or along a general specified path), regulating the power split under the constraints imposed by battery charge level, battery temperature and/or other aspects, such as vehicle stability, while adapting to the particular vehicle and driver.

In an aspect, a set of signals from the vehicle is acquired during the driving cycle on the specified circuit which feeds a real-time control function running in a system controller of the vehicle with information about the status of key components (e.g., battery, inverter, and electric motor (e-motor)), vehicle status data, and driver inputs.

In an aspect, an optimization function running online in the vehicle receives vehicle position reference from the navigation system, e.g. via GPS, in order to compute the optimal electrical and thermal power split based on the provided information. The power split ratio may determine the instantaneous contribution of electric motors to the total vehicle traction demand.

During driving of the vehicle, data acquired from the acquisition system and navigation system of the vehicle is used as input to run the real-time optimization function and update/adapt the torque split conditions (e.g., each straight section and/or curve) if the target position along the circuit and the status of physical quantities (e.g., estimated during an initial run) are not met. An updating process may terminate when the end of the circuit is reached.

Before driving of the vehicle, once the full path of the racetrack is known, the optimization algorithm may pre-deliver a recommended thermal/electric torque split (e.g., for hybrid vehicles) or electric split between front/rear axle (e.g., for electric vehicles) and limitations along the overall circuit based on vehicle status and initial conditions in order to get an optimized performance and minimum lap time. These settings may then get continuously updated during the actual driving.

Embodiments of the present disclosure provide improved performance behavior in terms of lap time, battery energy, and temperature distribution along consecutive laps of a racetrack. The control strategy according to embodiments of the present disclosure provides an optimal energy use, in real time, along consecutive laps of a racetrack, updating the results based on the current vehicle status and position in order to guarantee the best vehicle performance while avoiding battery thermal and power degradation with a consequent improving of lap times.

As used herein, the terms “vehicle” or “vehicular” or other similar terms are inclusive of motor vehicles in general. Such motor vehicles encompass passenger automobiles including race and sports cars, sports utility vehicles (SUVs), buses, trucks, various commercial vehicles, and the like. As used herein, the term “electric vehicle” includes battery electric vehicles, hybrid electric vehicles, such as plug-in hybrid electric vehicles, and vehicles running on alternative fuels, such as hydrogen-powered vehicles, or the like. Hence, an electric vehicle within the present meaning includes any motor vehicle having at least an electric machine, i.e., motor for propulsion, which can, however, be accompanied by one or several additional sources of power, e.g. an internal combustion engine. As used herein, a “hybrid vehicle” is a vehicle that has two or more sources of power, for example, a vehicle that is both gasoline-powered and electric-powered.

Advantageous embodiments and improvements of the present disclosure are disclosed and described herein.

According to an aspect, the system controller may further be configured to continuously control, based on the real-time control function, a torque distribution among mechanical braking and regenerative braking of the electric vehicle. The method may correspondingly include further continuously controlling, based on the real-time control function, a torque distribution among mechanical braking and regenerative braking of the electric vehicle.

Hence, a brake split between mechanical and regenerative braking (recuperation) may also be considered for performance optimization in order to further exploit the available optimization potential.

According to an aspect, the one or more pre-defined constraints on the vehicle status data may include a minimum allowed SOC of the traction battery, a maximum allowed SOC of the traction battery, a maximum allowed battery temperature of the traction battery, a maximum allowed temperature of an electric machine of the electric vehicle, limits on a current trajectory of the electric vehicle along the specified drive route, and/or traction limits of the electric vehicle.

For example, the minimum allowed state of charge of the traction battery may be set to the minimal possible level in order to achieve the best performance for one lap during a track race (i.e. full battery discharge after this one lap). Further, the maximum allowed temperature may be set adequately to avoid a potential power cut due to overheating. An application of this strategy may be, for example, an attempt to win the pole position during qualification for a race.

In another example, the focus may be put on avoiding long time stress on the traction battery, e.g. during an endurance race where the goal is to minimize the overall execution time (instead of merely a single lap time). In this case, the maximum allowed battery temperature may be limited more rigorously in order to avoid thermal derating and to guarantee uniform power delivery during the whole race.

According to an aspect, the specified drive route may be a closed racetrack that is circled multiple times by the electric vehicle.

Thus, embodiments of the present disclosure may be used on track races where a specified and very well-known closed circuit is repeatedly circled by an electric vehicle. It should be understood, however, that embodiments of the present disclosure can also be utilized for more general applications in which a certain route is to be followed that is known to a certain extent in advance and the powertrain behavior along the route can be optimized proactively.

According to an aspect, the sensor system may be further configured to acquire environmental data along the drive route. The system controller may be configured to consider the environmental data as input data for the real-time control function.

Environmental conditions may include, for example, weather and climate including ambient temperature but also road friction and similar aspects potentially affecting vehicle behavior along the route.

According to an aspect, the system controller may be further configured to collect information about the input data and control commands of the system controller based on the real-time control function along the specified drive route, and to store the collected information in a persistent data storage. The method may correspondingly further include collecting information about the input data and control commands of the system controller based on the real-time control function along the specified drive route and storing the collected information in a persistent data storage.

The collected data may be used afterwards in an offline procedure, for example when the vehicle rests, for improving accuracy and effectiveness of the optimization, e.g. by updating the control logic, such as the real-time control function, accordingly. Such control logic updates may then be deployed to the vehicle control unit to be used during the next trip. In a specific example, the data collected during the driving can be used to train an advance learning algorithm based on artificial intelligence and/or machine learning (AI/ML) during off-line operation.

According to an aspect, the system controller may be further configured to feed the collected information and/or simulation data about the vehicle behavior along the specified drive route to an artificial intelligence and/or machine learning entity to derive heuristic relationships between the input data and the control parameters of the real-time control function, taking into account the pre-defined constraints. The real-time control function may then be adapted based on the heuristic relationships. The method may correspondingly further comprise feeding the collected information and/or the simulation data about the vehicle behavior along the specified drive route to the artificial intelligence and/or machine learning entity to derive heuristic relationships between the input data and the control parameters of the real-time control function, taking into account the pre-defined constraint.

Hence, the collected data may be combined with detailed complete optimum lap simulation data (e.g. provided by the vehicle manufacturer) in an offline procedure in order to feed an AI/ML algorithm to update the analytical relations between the quantities for the real-time control function (represented by PCU control logic, for example), for example, in order to minimize the complexity of the optimization programming language.

Such an off-line procedure may be split into multiple steps. First, in a development phase before the vehicle is operated, a complete optimum lap simulation may be developed offline based on optimal control theory, which defines the optimum power split, e.g., between thermal and electrical source, using a complex vehicle physical model. Simulation data output analysis combined with AI/ML techniques and libraries may then define heuristic relationships between the relevant quantities to enable faster computational performance of the optimization problem. The output function and constraints from this procedure may then be used to simplify/reduce the optimum problem that would be implemented in the vehicle control system to run in real-time.

In a second step, after vehicle operation, all the data collected on a specific circuit or other specified path can be used to update the simplified optimum model after the vehicle mission. The updates can then be deployed to the system controller software through cloud computing processing infrastructures, for example.

In this context, a heuristic relationship between variables may be a link between variables that is determined using existing data, for example, data from the simulation model and/or data from the vehicle operation (collected and stored during driving). Such relationships between variables remove the need for the system controller to solve complex equations in real time, hence enabling the real time deployment of the optimum control strategy.

According to an aspect, the vehicle status data may further include vehicle speed, vehicle acceleration, electric parameters of the traction battery and/or operating speed of an electric machine and/or of an internal combustion engine of the electric vehicle.

According to an aspect, the driver requests may include acceleration demands, pedal positions and/or steering commands.

### BRIEF DESCRIPTION OF THE DRAWINGS

The accompanying drawings are included to provide a further understanding of the inventive concepts and are incorporated in and constitute a part of this specification. The drawings illustrate embodiments of the present disclosure and, together with the description, serve to explain the principles of inventive concepts. Other embodiments of the present disclosure and many of the intended advantages of the present disclosure should be readily appreciated as they become better understood by reference to the following detailed description. The elements of the drawings are not necessarily drawn to scale relative to each other. In the figures, like reference numerals denote like or functionally like components, unless indicated otherwise.

FIG. 1 schematically depicts an example drive route along which an electric vehicle may be driven based on a performance-optimized control of a powertrain of the electric vehicle, and depicts two example configurations of the electric vehicle, according to embodiments of the disclosure.

FIGS. 2 and 3 illustrate the energy and thermal behavior of an electric vehicle of FIG. 1 during circuit driving with and without using the optimized control according to embodiments of the disclosure.

FIG. 4 is a flow diagram of a method for performance-optimized control of the powertrain used in an electric vehicle of FIGS. 1-3, according to an embodiment of the present disclosure.

FIG. 5 is a block diagram of a control system for performance-optimized control used in the electric vehicles of FIGS. 1-3, according to an embodiment of the present disclosure.

Although specific embodiments are illustrated and described herein, it should be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION

When a component, device, element, or the like of the present disclosure is described as having a purpose or performing an operation, function, or the like, the component, device, or element should be considered herein as being “configured to” meet that purpose or perform that operation or function.

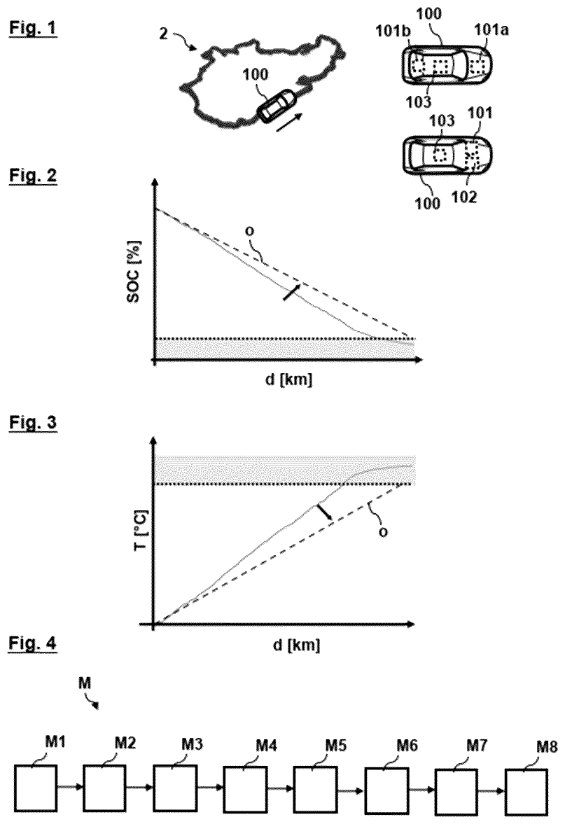

FIG. 1 schematically depicts an example drive route 2 along which an electric vehicle 100 may be driven based on a performance-optimized control of powertrain 11 of the electric vehicle, according to an embodiment of the present disclosure. The electric vehicle 100 may be a battery electric vehicle or a hybrid electric vehicle, e.g., a plug-in hybrid electric vehicle or other type of hybrid vehicle having an electric propulsion system and an internal combustion engine. As can be seen in FIG. 1, the drive route 2 may be a closed racetrack that may be circled by the electric vehicle 100 one or multiple (e.g., two or several) times, e.g., during a race, qualification, or training.

The electric vehicle 100 is illustrated in FIG. 1 in two example configurations. In a first configuration, the electric vehicle 100 is configured as a battery electric vehicle having a first motor or electric machine 101a driving a front axle of the electric vehicle 100 and a second motor or electric machine 101b driving a back axle of the electric vehicle 100. In a second configuration, the electric vehicle 100 is configured as a plug-in hybrid electric vehicle having a parallel arrangement of a motor or electric machine 101 and an internal combustion engine 102.

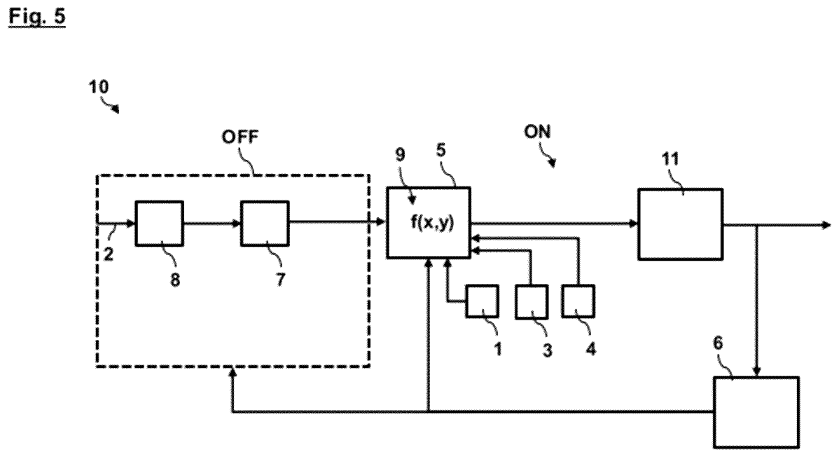

FIG. 4 is flow diagram of an example method M that may be implemented in the electric vehicle 100 of FIG. 1. In at least some embodiments, the method M provides improved powertrain control of the electric vehicle 100. FIG. 5 schematically depicts an example control system 10 for implementation of the method M of FIG. 4, according to an embodiment. In an example, the method M is performed to operate the powertrain 11 of the electric vehicle 100 at the highest possible performance level along the driving distance for optimal travel times.

To this end, the method M includes an operation M1 in which the drive route 2 for the electric vehicle 100 may be specified. The method M further includes an operation M2 in which a sensor system 1 of the electric vehicle 100 may acquire vehicle status data of the electric vehicle 100 along the drive route 2. The vehicle status data may include a state of charge (SOC) of a traction battery 103 of the electric vehicle 100 and a battery temperature T of the traction battery 103. However, these vehicle status data may be supplemented by further information that may include, without limitation, vehicle speed, vehicle acceleration, electric parameters of the traction battery 103 (e.g. battery current, battery voltage etc.) and/or operating speed of an electric machine 101, 101a, 101b and/or of an internal combustion engine 102 of the electric vehicle 100.

The method M further includes an operation M3 in which a navigation system 3 of the electric vehicle 100 may determine a current position of the electric vehicle 100 along the drive route 2. In an example, the navigation system 3 may determine current position of the electric vehicle 100 based on data of a global satellite positioning system, such as the global positioning system (GPS).

The method M further includes an operation M4 in which driver requests may be received via a driver interface 4 of the electric vehicle 100. Such driver requests may comprise, for example, acceleration demands, pedal positions and/or steering commands of the driver.

The method M further includes an operation M5 in which a control system controller 5 of the electric vehicle 100 (e.g. a powertrain control unit, PCU) may continuously control, based on a real-time control function 9 using the vehicle status data, the current position, and the driver requests as input data, parameters along the specified drive route 2 based on. In the first configuration of the electric vehicle 100 of FIG. 1, the control parameters may comprise a torque distribution among the first electric machine 101a of the electric vehicle 100 and the second electric machine 101b. In the second configuration, the control parameters may comprise a torque distribution among the electric machine 101 of the electric vehicle 100 and the internal combustion engine 102 of the electric vehicle 100.

It should be understood that these control parameters could also be combined with each other in different vehicle configurations. Moreover, other parameters may be additionally or alternatively controlled by the control system 5. In an example, the control system 5 may additionally or alternatively control a torque distribution among mechanical braking and regenerative braking of the electric vehicle 100.

In some examples, additional or alternative parameters may be used as input data for the real-time control function 9. For example, environmental data taken by the sensor system 1 along the drive route 2 including ambient temperature, road conditions and so on, may be used as input data.

The real-time control function 9 may be adapted to minimize a travel time along at least a portion of the specified drive route 2 while conforming to pre-defined constraints on the vehicle status data. The pre-defined constraints on the vehicle status data may include, for example, a minimum and/or maximum allowed state of charge SOC of the traction battery 103, a maximum allowed battery temperature T of the traction battery 103, a maximum allowed temperature of an electric machine 101, 101a, 101b of the electric vehicle 100, limits on a current trajectory of the electric vehicle 100 along the specified drive route 2, and traction limits of the electric vehicle.

An optimization method is a numerical algorithm that defines a set of variables x satisfying a given set of equations describing the evolution of a system within defined set of constraints, e.g., g (x (t)) and h (x (t)), and maximizes or minimizes a specific cost function f (target). The numerical algorithm may be described by the following set of equations:

Φ=min f (x (t)), g (x (t))=0, h (x (t))≤0

In an embodiment, the set of equations describes the evolution of vehicle dynamics for each of a plurality of positions along a given path of the drive route 2. The control variables x (t) may define the torque split between ICE/e-motor and/or between front and rear axles for every time interval, taking into account the thermodynamic and aerodynamic laws and the physical constraints of the system as well as the path constraints, defined by the drive route 2. Example parameters are summarized in the following table:

| Input data | Constraints |
|---|---|
| Circuit path and grade | Min/Max SOC |
| Driver demand/pedal position | Max battery temperature |
| Vehicle position | Max e-motor temperature |
| Vehicle speed | Traction limits |
| Vehicle longitudinal acceleration | Circuit path lateral limits |
| Vehicle lateral acceleration | Circuit lenght |
| Traction torque | Control parameters |
| Battery current | e-motor torque |
| Battery Voltage | Regeneration torque |
| Battery SOC | Brake torque |
| e-motor speed | Engine torque (for |
| | hybrid architecture) |
| Wheel speed | Engine transmission gear-shift |
| Engine speed | e-motor gear-shift |

In the set of equations, g (x (t)) describes the vehicle dynamic model, while in the set of equations, h (x (t)) describes the technology limitations (e.g., maximum speed, maximum torque, and so on). The overall objective function f (x (t)) defines the time t (independent variable) to execute the mission. The goal of the optimization algorithm is to outline a particular x (t) that minimizes the total execution time.

The above-described algorithm is relatively complex and may require computational capability that may not be available in typical vehicle powertrain control units. Accordingly, in an example, implementation of the algorithm may be split up into an offline part and a low order reduction of the problem (e.g., through AI/ML techniques) that may be used in an on-line implementation in the electric vehicle 100 during driving. The algorithm implemented in the control system 10 of the electric vehicle 100 may thus be based on a low order reduction control function that approximates the results of the complex numerical optimization, satisfying the x and u conditions within the constraints c. The offline part, on the other hand, may be fed with data acquired during driving of the electric vehicle 100 and may then be used to successively update and improve the real-time control function.

Accordingly, the method M may further include an operation M6 in which information about the input data and control commands of the system controller 5 may be collected based on the real-time control function 9 along the specified drive route 2. The method M may further include an operation M7 in which the collected information may be stored in a persistent data storage 6 of the electric vehicle 100.

The method M may also include an operation M8 in which the collected information and/or simulation data about the vehicle behavior along the specified drive route 2 may be provided to an artificial intelligence and/or machine learning engine 7 to derive heuristic relationships between the input data and the control parameters of the real-time control function 9, taking into account the pre-defined constraints. The real-time control function 9 may then be adapted based on the heuristic relationships.

For example, AI/ML may be used in a time series pattern recognition for vehicle speed prediction (e.g., 10 s ahead). In various example, Recurrent Neural Networks (RNNs) and/or Long Short-Term Memory (LSTM) Neural networks may be employed. Vehicle speed and time may serve as inputs and the predicted vehicle speed for the next 10 s may be provided as output (e.g. using a 30 s running history window of the current vehicle speed). Thus, power demand from an electric vehicle (xEV) powertrain over the next 10 s may be identified and used to apply predictive control and hence reduce the complexity of the calculation in real time to achieve optimal control. For example, if a long (e.g., 10 s) deceleration is predicted, one could ensure that the battery SoC and T allow for maximum possible regeneration.

In another example, discrete events may be predicted. Multi-Layer Perceptron (MLP) neural networks may be used, for example, for the prediction of a start point in time of a generic vehicle speed profile (e.g. vehicle coasting, capture of max. vehicle speed). In this example, input data may include the vehicle speed, vehicle accelerations (e.g., longitudinally, laterally), pedal displacements (e.g., braking, acceleration), steering wheel angles and speed, and the like. The model may then output a predicted start time, e.g., for a coasting event or the reaching of maximum speed. The identification of coasting events would allow the control architecture to turn off the internal the combustion engine for the duration of the coasting event and thus save fuel in a hybrid electric vehicle (xHEV) powertrain. The application of a pre-defined strategy for torque split (combustion engine vs. electric motor) around the maximum speed point (+/−5 s) may be used for optimum energy efficiency or performance. For example, the electric motor may be turned off in this time interval if it operates in an inefficient torque-speed region. There may be no requirement to execute real time complex algorithms in order to apply the optimum torque split.

FIGS. 2 and 3 illustrate the energy and thermal behavior of the electric vehicle 100 of FIG. 1 during circuit driving with and without using the optimized control according to embodiments of the present disclosure. By introducing constraints on the maximum allowed battery temperature T (cf. FIG. 3) and the minimum allowed state of charge SOC (cf. FIG. 2), thermal deration and power cuts may be prevented and the powertrain 11 and the traction battery 103 of the electric vehicle may be operated in an optimized way (cf. optimized trendline “o” in FIGS. 2 and 3).

In an example, the goal may be to achieve a minimal lap time for the final lap in a qualifying session of a dedicated race on the track 2 depicted in FIG. 1. In this example, the input data may comprise vehicle initial conditions such as battery temperature set to a defined optimum value (pre-conditioning) and vehicle states, such as pedal position, vehicle speed and position, SOC, and the like. As constraints, the minimal SOC may be set to the minimum possible level (e.g., full battery discharge after the final lap to get the best performance) and a maximal battery temperature may be set to avoid a severe power cut. Control parameters may include e-motor/ICE torque, regenerative/mechanical braking torque, e-motor/engine gearshift etc., for example.

In another example, a race may comprise at least two or several laps on the route 2 depicted in FIG. 1. In this example, the focus may be put on a balanced stress for the traction battery 103 of the electric vehicle 100 while minimizing overall travel time, thereby guarantying uniform performance, and avoiding thermal derating. The abovementioned input data may be supplemented by the number of laps in this case. An important constraint may then be placed on the maximal battery temperature to avoid thermal derating and to guarantee uniform power delivery.

In the foregoing detailed description, various features have been grouped together in one or more examples for the purpose of streamlining the disclosure. It should be understood that the above description is intended to be illustrative, and not restrictive. The present disclosure is intended to cover various alternatives, modifications, and equivalents of the different features and embodiments. Many other examples should be apparent to those having ordinary skill in the art upon reviewing the above specification. The disclosed embodiments are shown and described in order to explain the principles of the inventive concepts and its practical applications to thereby enable others having ordinary skill in the art to utilize the present disclosure and various embodiments with various modifications as are suited to the particular use contemplated.

### REFERENCE LIST

1 sensor system
2 drive route
3 navigation system
4 driver interface
5 system controller
6 data storage
7 artificial intelligence and/or machine learning engine
8 driving simulation
9 real-time control function
10 control system
11 powertrain
100 electric vehicle
101, 101a-b electric machine
102 internal combustion engine
103 traction battery
o optimized trendline
OFF offline procedure
ON online procedure
d distance
SOC state of charge
T battery temperature
M method
M1-M8 method steps

What is claimed is:

1. A method for performance-optimized control of a powertrain of an electric vehicle, the method comprising:
acquiring, by a sensor system of the electric vehicle, vehicle status data of the electric vehicle along a specified drive route for the electric vehicle, the vehicle status data including a state of charge (SOC) of a traction battery of the electric vehicle and a battery temperature of the traction battery;
determining, by a navigation system of the electric vehicle, a current position of the electric vehicle along the specified drive route;
receiving driver requests via a driver interface of the electric vehicle; and
continuously controlling, by a system controller of the electric vehicle based on a real-time control function using the vehicle status data, the current position and the driver requests as input data, at least one control parameter along the specified drive route, the at least one control parameter including at least one of
a torque distribution among a first electric machine driving a front axle of the electric vehicle and a second electric machine driving a back axle of the electric vehicle, or
a torque distribution among an electric machine of the electric vehicle and an internal combustion engine of the electric vehicle,
wherein the real-time control function is adapted to minimize a travel time along at least a portion of the specified drive route while conforming to one or more pre-defined constraints on the vehicle status data.

2. The method according to claim 1, wherein continuously controlling the at least one control parameter based on the real-time control function further comprises controlling a torque distribution among mechanical braking and regenerative braking of the electric vehicle.

3. The method according to claim 1, wherein the one or more pre-defined constraints on the vehicle status data comprise at least one of a minimum allowed SOC of the traction battery, a maximum allowed SOC of the traction battery, a maximum allowed battery temperature of the traction battery, a maximum allowed temperature of an electric machine of the electric vehicle, limits on a current trajectory of the electric vehicle along the specified drive route, or traction limits of the electric vehicle.

4. The method according to claim 1, wherein the drive route is a closed racetrack that is circled multiple times by the electric vehicle.

5. The method according to claim 1, further comprising:
acquiring, by the sensor system, environmental data along the specified drive route; and
providing the environmental to the system controller as input data for the real-time control function.

6. The method according to claim 1, further comprising:
collecting information about the input data and control commands of the system controller based on the real-time control function along the specified drive route; and
storing the collected information in a persistent data storage.

7. The method according to claim 6, further comprising feeding at least one of the collected information or simulation data about the vehicle behavior along the specified drive route to one or both of an artificial intelligence engine or a machine learning engine to derive heuristic relationships between the input data and the control parameters of the real-time control function, taking into account the pre-defined constraints, wherein the real-time control function is adapted based on the heuristic relationships.

8. The method according to claims 1, wherein the vehicle status data further includes at least one of vehicle speed, vehicle acceleration, electric parameters of the traction battery, operating speed of an electric machine of the electric vehicle, or operating speed of an internal combustion engine of the electric vehicle.

9. The method according to claim 1, wherein the driver requests include at least one of acceleration demands, pedal positions, or steering commands.

10. A control system for performance-optimized control of a powertrain of an electric vehicle, the control system comprising:
a sensor system configured to acquire vehicle status data of the electric vehicle along a specified drive route of the electric vehicle, the vehicle status data including a state of charge (SOC) of a traction battery of the electric vehicle and a battery temperature of the traction battery;
a navigation system configured to determine a current position of the electric vehicle along the specified drive route;
a driver interface configured to receive driver requests; and
a system controller configured to continuously control, based on a real-time control function using the vehicle status data, the current position and the driver requests as input data, at least one control parameter along the specified drive route, the at least one control parameter including at least one of
a torque distribution among a first electric machine driving a front axle of the electric vehicle and a second electric machine driving a back axle of the electric vehicle, or
a torque distribution among an electric machine of the electric vehicle and an internal combustion engine of the electric vehicle,
wherein the real-time control function is adapted to minimize a travel time along at least a portion of the specified drive route while conforming to one or more pre-defined constraints on the vehicle status data.

11. The control system according to claim 10, wherein the system controller is further configured to continuously control, based on the real-time control function, a torque distribution among mechanical braking and regenerative braking of the electric vehicle.

12. The control system according to claim 10, wherein the one or more pre-defined constraints on the vehicle status data include at least one of a minimum allowed SOC of the traction battery, a maximum allowed SOC of the traction battery, a maximum allowed battery temperature of the traction battery, a maximum allowed temperature of an electric machine of the electric vehicle, limits on a current trajectory of the electric vehicle along the specified drive route, or traction limits of the electric vehicle.

13. The control system according to claim 10, wherein the specified drive route is a closed racetrack that is circled multiple times by the electric vehicle.

14. The control system according to claim 10, wherein:
the sensor system is further configured to acquire environmental data along the specified drive route; and
the system control is configured to consider the environmental data as input data for the real-time control function.

15. The control system according to claim 10, wherein the system controller is further configured to:
collect information about the input data and control commands of the system control based on the real-time control function along the specified drive route; and
store the collected information in a persistent data storage.

16. The control system according to claim 15, wherein the system controller is further configured to feed at least one of the collected information or simulation data about the vehicle behavior along the specified drive route to one or both of an artificial intelligence engine or a machine learning engine to derive heuristic relationships between the input data and the control parameters of the real-time control function, taking into account the pre-defined constraints, wherein the real-time control function is adapted based on the heuristic relationships.

17. The control system according to claim 10, wherein the vehicle status data further includes at least one of vehicle speed, vehicle acceleration, electric parameters of the traction battery, operating speed of an electric machine of the electric vehicle, or operating speed of an internal combustion engine of the electric vehicle.

18. The control system according to claim 10, wherein the driver requests include at least one of acceleration demands, pedal positions, or steering commands.

19. An electric vehicle having a control system for performance-optimized control of a powertrain of the electric vehicle, the control system comprising:
a sensor system configured to acquire vehicle status data of the electric vehicle along a specified drive route of the electric vehicle, the vehicle status data including a state of charge (SOC) of a traction battery of the electric vehicle and a battery temperature of the traction battery;
a navigation system configured to determine a current position of the electric vehicle along the specified drive route;
a driver interface configured to receive driver requests; and
a system controller configured to continuously control, based on a real-time control function using the vehicle status data, the current position, and the driver requests as input data, at least one control parameter along the specified drive route, the at least one control parameter including at least one of
a torque distribution among a first electric machine driving a front axle of the electric vehicle and a second electric machine driving a back axle of the electric vehicle, or
a torque distribution among an electric machine of the electric vehicle and an internal combustion engine of the electric vehicle,
wherein the real-time control function is adapted to minimize a travel time along at least a portion of the specified drive route while conforming to one or more pre-defined constraints on the vehicle status data.
